(19) United States
(12) Patent Application Publication
(10) Pub. No.: US 2004/0169097 A1
(43) Pub. Date: Sep. 2, 2004

(54) Method and apparatus for improving palatability and digestability of baled feed

(76) Inventors: Al Hersberger, St. Paul (CA); Gerald Michaud, St. Paul (CA)

Correspondence Address: FROST BROWN TODD, LLC, 2200 PNC CENTER, 201 E. FIFTH STREET, CINCINNATI, OH, 45202, US

(21) Appl. No.: 10/376,990

(22) Filed: Feb. 28, 2003

(51) Int. Cl. B02C 19/12

(52) U.S. Cl. 241/30; 241/605

(57) ABSTRACT

A method of improving the palatability and digestability of bales of forage materials comprises carrying a quantity of a molasses based liquid feed supplement in a container mounted on a bale shredder; shredding the bales in the bale shredder and discharging a stream of shredded bale material through a discharge opening in the bale shredder; and spraying the molasses based liquid feed supplement into the stream of shredded bale material as it is discharged and prior to the stream landing on the ground such that the molasses based liquid feed supplement mixes with the shredded bale material and adheres to the shredded bale material. A modified bale shredder and a kit to retrofit existing bale shredders are also provided.

This invention is in the field of feed for livestock, and in particular such feed in the form of baled forage materials.

### BACKGROUND OF THE INVENTION

Hay, straw, and like forage materials are commonly formed into bales for storage and later feeding to livestock. The quality of such bales varies significantly depending on the feed quality of the forage material baled, the length of time the bales have been stored, the storage conditions, and so forth.

Often where the forage quality is poor, or where the bales have been stored for a lengthy time the palatability of the shredded bale material is poor and livestock will not readily eat it. Also once eaten, poor quality feed is not well digested in the animal's system.

It is known to add sugar, commonly molasses, to feed material to improve both palatability and digestion. The molasses sticks to the feed material improving palatability. The livestock readily eat the feed material to get the molasses, and once eaten digestion of the feed material is improved by the added sugar.

It is most often desirable to feed the livestock other feed products, such as grain, protein pellets, vitamins, minerals, and the like, in addition to the baled material to ensure that the nutrient requirements of the livestock are met.

Liquid supplements with a molasses base are available that contain a ration of vitamins, minerals, nutrients, and such other feed additives as may be desirable. These liquid feed supplements can be readily formulated to meet an individual livestock producer's needs. Presently, such liquid supplements are commonly added to the bales by pouring a quantity over the bale and allowing it to soak in. Such methods are problematic however. Where the bales are soft, a significant portion of the liquid can run right through the bale and be lost. Where the bales are hard, the liquid will not penetrate the bale as desired.

Since the liquid is often not evenly distributed through the bale, substantial portions of the baled material are not covered with the sweet molasses and remain unpalatable.

Bale shredders are often used to shred the bales and discharge the shredded bale material into feed bunks or onto the ground where it is eaten by the livestock. Shredding the bales improves palatability by reducing course stalks and the like into smaller, more readily eaten and digested pieces. Such bale shredders are well known in the prior art. Typical bale shredders are illustrated for example in U.S. Pat. No. 5,340,040 to Bussiere et al. and U.S. Pat. No. 5,601,241 to Brewster, and in Canadian Patent Number 2,282,895 to Hruska.

The '895 patent of Hruska discloses a hopper mounted on the bale shredder for carrying a supplemental feed product in a particulate form, and an auger conveyor or like means to deposit the supplemental product on top of the shredded bale material. The apparatus deposits the supplemental product on top of the shredded bale material where it is readily available to the livestock, however a significant portion of the particles can shake down through the shredded bale material to the ground when the livestock are eating and be lost.

The particulate form also does not particularly improve the palatability of the shredded bale material, since the particles remain separate from the shredded bale material. The livestock can pick the particles out of the less palatable material and eat them, leaving the less palatable shredded bale material uneaten.

### SUMMARY OF THE INVENTION

It is an object of the present invention to provide a method and apparatus for improving the palatability and digestability of bales of forage materials that overcomes problems in the prior art. It is a further object of the present invention to provide such a method wherein molasses based liquid feed supplement is mixed with shredded bale material as it exits a bale shredder so that the molasses based liquid feed supplement is mixed with and adheres to the material, making it taste sweet and palatable, and improving digestion by adding sugar in the animals diet.

The present invention provides, in one aspect, a method of improving the palatability and digestability of bales of forage materials. The method comprises carrying a quantity of a molasses based liquid feed supplement in a container mounted on a bale shredder; shredding the bales in the bale shredder and discharging a stream of shredded bale material through a discharge opening in the bale shredder; and spraying the molasses based liquid feed supplement into the stream of shredded bale material as it is discharged and prior to the stream landing on the ground such that the molasses based liquid feed supplement mixes with the shredded bale material and adheres to the shredded bale material.

The present invention provides, in a second aspect, a kit for use with a bale shredder to improve the palatability and digestability of bales of forage materials by mixing a molasses based liquid feed supplement with shredded bale material as it is discharged from a discharge opening on the bale shredder. The kit comprises a container adapted for mounting on the bale shredder for carrying a quantity of the molasses based liquid feed supplement; a nozzle adapted for mounting in proximity to the discharge opening such that liquid sprayed from the nozzle is directed into the stream of shredded bale material; and a pump operative to pump the molasses based liquid feed supplement from the container through a conduit to the nozzle such that the molasses based liquid feed supplement is sprayed into the stream of shredded bale material as it is discharged and prior to the stream landing on the ground such that the molasses based liquid feed supplement mixes with the shredded bale material and adheres to the shredded bale material.

The present invention provides, in a third aspect, an apparatus to improve the palatability and digestability of bales of forage materials by mixing a molasses based liquid feed supplement with shredded bale material. The apparatus comprises a bale shredder operative to shred bales and discharge a stream of shredded bale material from a discharge opening on one side of the bale shredder; a container mounted on the bale shredder for carrying a quantity of the molasses based liquid feed supplement; a nozzle mounted in proximity to a front end of the discharge opening such that liquid sprayed from the nozzle is directed rearward and into the stream of shredded bale material; and a pump operative to pump the molasses based liquid feed supplement from the container through a conduit to the nozzle such that the molasses based liquid feed supplement is sprayed into the stream of shredded bale material as it is discharged and prior to the stream landing on the ground such that the molasses based liquid feed supplement mixes with the shredded bale material and adheres to the shredded bale material.

The nozzle sprays the molasses based liquid feed supplement into the turbulent discharge of shredded bale material exiting from the discharge opening, such that the supplement is mixed thoroughly with the individual pieces of shredded material. Unlike the prior art where particles are simply dropped into the shredded bale material where they can fall through to the ground or be picked out by the animals, the molasses makes the supplement sticky, and so it adheres to the individual pieces making them sweet and much more palatable and liable to be eaten, even where the quality of the baled forage material is poor.

The kit of the invention allows the method to be practiced using existing bale shredders which many animal feeders already have, thus providing an economical apparatus for practicing the invention.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic front view of an embodiment of a bale shredder for practicing the invention;

FIG. 2 is a side view of the embodiment of FIG. 1.

### DETAILED DESCRIPTION OF THE ILLUSTRATED EMBODIMENTS

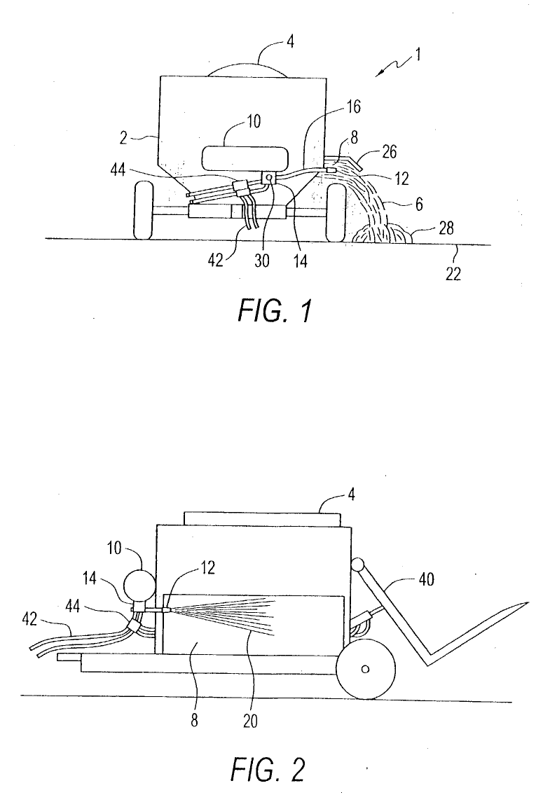

FIGS. 1 and 2 schematically illustrate an apparatus 1 to improve the palatability and digestability of bales of forage materials by mixing a molasses based liquid feed supplement with shredded bale material. The apparatus comprise a bale shredder 2 operative to shred bales 4 and discharge a stream 6 of shredded bale material from a discharge opening 8 on one side of the bale shredder 2. The illustrated bale shredder 2 is one of that type that is well known for shredding large round bales, although other types of bale shredders may be used as well.

A container 10 is mounted on the bale shredder 2 for carrying a quantity of the molasses based liquid feed supplement. The container 10 is shown mounted on the front end of the bale shredder 2 however the location could also be one side or the rear, depending on the particular bale shredder.

A nozzle 12 is mounted in proximity to a front end of the discharge opening 8 such that liquid sprayed from the nozzle 12 is directed rearward and into the stream 6 of shredded bale material. It has been found that a flat fan nozzle works well, however it is contemplated that nozzles with other spray patterns would also work. The nozzle 12 could also be located at the rear of the discharge opening 8 such that sprayed liquid is directed forward. Bales sometimes jam in the bale shredder 2 such that the stream 6 of shredded bale material is interrupted. When this happens the sprayed liquid is not blocked by the stream 6 and will land on the tractor towing the bale shredder, making a mess.

A pump 14 is connected to the container 10 and is operative to pump the molasses based liquid feed supplement from the container 10 through a conduit 16 to the nozzle 12 such that the molasses based liquid feed supplement 20 is sprayed into the stream 6 of shredded bale material as it is discharged and prior to the stream landing on the ground 22. FIG. 1 illustrates the stream 6 of shredded bale material exiting the discharge opening 8, however in FIG. 2, the stream 6 is omitted so that the pattern of the sprayed molasses based liquid feed supplement can be illustrated.

As illustrated in FIG. 1, the bale shredder 2 comprises a guide 26 to direct the stream of shredded bale material downward into a windrow 28. The nozzle 12 is mounted such that the molasses based liquid feed supplement is sprayed into the stream 6 of shredded bale material between the discharge opening and the guide.

The molasses based liquid feed supplement mixes with the shredded bale material and adheres to the shredded bale material. Looking in the windrow 28 of shredded bale material after the bale shredder 2 has passed discloses that the great majority, virtually all of the pieces of bale material have at least some of the molasses based liquid feed supplement sticking to them. The pieces are thus much more palatable as they taste sweet to the animals. The sugar in the molasses also aids in digestion of the bale material in the animal's system.

The molasses based liquid feed supplement can conveniently be formulated to contain whatever feed additives, minerals, vitamins, and the like that are desired by the user, combined with molasses in a liquid formulation. A complete ration can usually be supplied to the livestock in this manner.

A spray rate adjuster 30 operative to adjust the rate of molasses based liquid feed supplement being sprayed from the nozzle 12. The operator can calibrate the system to apply the proper amount of molasses based liquid feed supplement to the shredded bale material from a single bale. While bales vary somewhat in size and weight it is generally the case that an average of the bale weight will give satisfactory results.

For example where the operator wishes to feed 15 kilograms of bale material to each animal, and the bales weigh an average of 450 kilograms, each bale will feed 30 animals. If the operator wants to also feed 0.5 liters of molasses based liquid feed supplement to each animal, then 15 liters are required for the 30 animals fed by a bale.

The operator then times the bale shredder to determine the shredding time required to shred a bale, typically between 30 and 120 seconds. Where the shredding time is 60 sec or one minute, for example, the spray rate adjuster would be used to adjust the spray rate to 15 liters/minute. The operator would then begin to spray the molasses based liquid feed supplement and begin to shred a bale at substantially the same time, and then cease to spray the molasses based liquid feed supplement when the bale shredder has finished shredding the bale.

The bale shredder 2 comprises a fork apparatus 40 at a rear end thereof for loading bales 4 into the bale shredder. This is a common feature on bale shredders as the fork apparatus 40 not only loads a bale into the bale shredder but carries a second bale so that two bale can be transported from a storage site to a feeding site at the same time. The fork apparatus 40 is operated by hydraulic power supplied through hydraulic lines 42 connected to a tractor. Conveniently the pump 14 can be powered by connecting a hydraulic valve 44 to the hydraulic lines 42 to divert hydraulic power from the fork apparatus 40 to the pump 14. Since the fork apparatus 40 is not generally operated when the bale is being shredded, the operator can divert the oil to the pump 14 or fork apparatus 40 as desired with a remote control located in the tractor cab.

Conveniently as well, mechanisms can be incorporated so that the pump 14 can be operated to transfer molasses based liquid feed supplement from a storage site into the container 10, thereby obviating the need for another pump.

Conveniently as well the apparatus can be supplied as a kit comprising the container 10, nozzle 12, pump 14, and conduit 16 adapted to be mounted by brackets or the like on various existing models of bale shredders. The required hydraulic lines and fittings, and valve 44 could also be supplied where it was desired to use hydraulic power to operate the pump 14.

The method of the invention for improving the palatability and digestability of bales 4 of forage materials comprises carrying a quantity of a molasses based liquid feed supplement in a container 10 mounted on a bale shredder 2; shredding the bales 4 in the bale shredder 2 and discharging a stream 6 of shredded bale material through a discharge opening 8 in the bale shredder 2; and spraying the molasses based liquid feed supplement into the stream 6 of shredded bale material as it is discharged and prior to the stream 6 landing on the ground 22 such that the molasses based liquid feed supplement mixes with the shredded bale material and adheres to the shredded bale material.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A method of improving the palatability and digestability of bales of forage materials, the method comprising:
carrying a quantity of a molasses based liquid feed supplement in a container mounted on a bale shredder;
shredding the bales in the bale shredder and discharging a stream of shredded bale material through a discharge opening in the bale shredder;
spraying the molasses based liquid feed supplement into the stream of shredded bale material as it is discharged and prior to the stream landing on the ground such that the molasses based liquid feed supplement mixes with the shredded bale material and adheres to the shredded bale material.

2. The method of claim 1 wherein spraying the molasses based liquid feed supplement comprises pumping the molasses based liquid feed supplement from the container through a conduit to a nozzle mounted in proximity to the discharge opening such that liquid sprayed from the nozzle is directed into the stream of shredded bale material.

3. The method of claim 2 wherein the discharge opening is located on one side of the bale shredder and wherein the nozzle is located in proximity to a front end of the discharge opening and liquid sprayed from the nozzle is directed rearward into the stream of shredded bale material.

4. The method of claim 1 wherein the bale shredder comprises a guide to direct the stream of shredded bale material downward into a windrow, and wherein the molasses based liquid feed supplement is sprayed into the stream of shredded bale material between the discharge opening and the guide.

5. The method of claim 1 further comprising:
determining a desired quantity of molasses based liquid feed supplement desired to be mixed with shredded bale material from a single bale;
determining the shredding time required to shred a single bale;
adjusting a rate of spraying the molasses based liquid feed supplement such that the desired quantity thereof is sprayed into the stream in the shredding time;
beginning to spray the molasses based liquid feed supplement and beginning to shred a bale at substantially the same time; and
ceasing to spray the molasses based liquid feed supplement when the bale shredder has finished shredding the bale.

6. The method of claim 1 wherein the bale shredder comprises a fork apparatus at a rear end thereof for loading bales into the bale shredder, and wherein the fork apparatus is operated by hydraulic power supplied through hydraulic lines connected to a tractor, and wherein a pump is operative to spray the molasses based liquid feed supplement, and wherein the pump is operated by hydraulic power diverted from the hydraulic lines supplying the fork apparatus.

7. The method of claim 6 further comprising using the pump to transfer molasses based liquid feed supplement from a storage site into the container.

8. A kit for use with a bale shredder to improve the palatability and digestability of bales of forage materials by mixing a molasses based liquid feed supplement with shredded bale material as it is discharged from a discharge opening on the bale shredder, the kit comprising:
a container adapted for mounting on the bale shredder for carrying a quantity of the molasses based liquid feed supplement;
a nozzle adapted for mounting in proximity to the discharge opening such that liquid sprayed from the nozzle is directed into the stream of shredded bale material;
a pump operative to pump the molasses based liquid feed supplement from the container through a conduit to the nozzle such that the molasses based liquid feed supplement is sprayed into the stream of shredded bale material as it is discharged and prior to the stream landing on the ground such that the molasses based liquid feed supplement mixes with the shredded bale material and adheres to the shredded bale material.

9. The kit of claim 8 wherein the discharge opening is located on one side of the bale shredder and wherein the nozzle is adapted for mounting in proximity to a front end of the discharge opening and liquid sprayed from the nozzle is directed rearward into the stream of shredded bale material.

10. The kit of claim 8 wherein the bale shredder comprises a guide to direct the stream of shredded bale material downward into a windrow, and wherein the nozzle is adapted for mounting such that the molasses based liquid feed supplement is sprayed into the stream of shredded bale material between the discharge opening and the guide.

11. The kit of claim 8 further comprising a spray rate adjuster operative to adjust the rate of molasses based liquid feed supplement being sprayed from the nozzle such the operator can determine a desired quantity of molasses based liquid feed supplement desired to be mixed with shredded bale material from a bale and spray that desired quantity out of the nozzle in a period of time substantially equal to a time required to shred a bale.

12. The kit of claim 8 wherein the bale shredder comprises a fork apparatus at a rear end thereof for loading bales into the bale shredder, and wherein the fork apparatus is operated by hydraulic power supplied through hydraulic lines connected to a tractor, and further comprising a hydraulic valve adapted for connection to the hydraulic lines and operative to divert hydraulic power from the fork apparatus to the pump to operate the pump.

13. The kit of claim 8 wherein the pump can be operated to transfer molasses based liquid feed supplement from a storage site into the container.

14. An apparatus to improve the palatability and digestability of bales of forage materials by mixing a molasses based liquid feed supplement with shredded bale material, the apparatus comprising:
a bale shredder operative to shred bales and discharge a stream of shredded bale material from a discharge opening on one side of the bale shredder;
a container mounted on the bale shredder for carrying a quantity of the molasses based liquid feed supplement;
a nozzle mounted in proximity to a front end of the discharge opening such that liquid sprayed from the nozzle is directed rearward and into the stream of shredded bale material;
a pump operative to pump the molasses based liquid feed supplement from the container through a conduit to the nozzle such that the molasses based liquid feed supplement is sprayed into the stream of shredded bale material as it is discharged and prior to the stream landing on the ground such that the molasses based liquid feed supplement mixes with the shredded bale material and adheres to the shredded bale material.

15. The apparatus of claim 14 wherein the bale shredder comprises a guide to direct the stream of shredded bale material downward into a windrow, and wherein the nozzle is mounted such that the molasses based liquid feed supplement is sprayed into the stream of shredded bale material between the discharge opening and the guide.

16. The apparatus of claim 14 further comprising a spray rate adjuster operative to adjust the rate of molasses based liquid feed supplement being sprayed from the nozzle such the operator can determine a desired quantity of molasses based liquid feed supplement desired to be mixed with shredded bale material from a bale and spray that desired quantity out of the nozzle in a period of time substantially equal to a time required to shred a bale.

17. The apparatus of claim 14 wherein the bale shredder comprises a fork apparatus at a rear end thereof for loading bales into the bale shredder, and wherein the fork apparatus is operated by hydraulic power supplied through hydraulic lines connected to a tractor, and further comprising a hydraulic valve connected to the hydraulic lines and operative to divert hydraulic power from the fork apparatus to the pump to operate the pump.

18. The apparatus of claim 14 wherein the pump can be operated to transfer molasses based liquid feed supplement from a storage site into the container.
